(19) United States
(12) Patent Application Publication
(10) Pub. No.: US 2017/0175425 A1
(43) Pub. Date: Jun. 22, 2017

(54) PADDLEBOARD ANTI-THEFT DEVICE AND METHOD

(71) Applicant: Susan Westbrook, Canyon Lake, CA (US)

(72) Inventor: Susan Westbrook, Canyon Lake, CA (US)

(21) Appl. No.: 15/382,488

(22) Filed: Dec. 16, 2016

Related U.S. Application Data
(60) Provisional application No. 62/269,878, filed on Dec. 18, 2015.

(51) Int. Cl. E05B 73/00; E05B 67/38; B63B 35/85

(52) U.S. Cl. CPC E05B 73/007; B63B 35/85; E05B 73/0005; E05B 67/38

(57) ABSTRACT

The present invention is generally an anti-theft device, or locking mechanism suitable for anchoring a paddleboard to a fixed object. The locking mechanism may include a support body configured to engage with a fin box of a board such as a paddleboard or surfboard. In exemplary embodiments, the support body includes a cubical frame with one or more openings—for example, an opening on each face of the cubical frame—that enables a locking means, such as a lock or lockable cable to engage with the support body. Because the support body can be securely attached to the fin box of a board, when the locking means is engaged to the support body, the board will be secured to a fixed object, and unauthorized removal of the board is prevented.

### PRIORITY NOTICE

The present application claims priority under 35 U.S.C. §119(e) to U.S. Provisional Patent Application with Ser. No. 62/269,878, filed on Dec. 18, 2015, the disclosure of which is incorporated herein by reference in its entirety.

### TECHNICAL FIELD OF THE INVENTION

The present invention relates in general to an anti-theft device and method, and more specifically, to an anti-theft device or locking mechanism for securing a paddleboard to an anchoring means or fixed object, thereby preventing unauthorized removal. Methods of installing and using the anti-theft device are also disclosed.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

With the ever-increasing popularity of water sports such as surfing or paddle boarding, enthusiasts often find themselves having to worry about theft. The concern typically arises when enthusiasts take their boards on a vehicle, or walk their boards to a nearby beach or lake, and decide to temporarily engage in other activities. For example, it is common to take a trip and strap a paddle board to the roof of a vehicle, and at some point, stop somewhere to eat; this will require leaving the vehicle, and hence the paddleboard, unattended. At such times, it would be typically easy for a bystander to remove the board without authorization by the owner, unless a locking means has been implemented to prevent the unauthorized removal of the board. The crux of the problem is properly securing boards to prevent their theft.

Properly securing these boards has been problematic for several reasons. First, the very designs for paddleboards, or similar devices including surfboards, long boards, or prone boards, make it difficult to affix or secure the boards to a fixed object or anchoring means because the body of the board typically has no openings or components that allow for a secure attachment to the fixed object.

The prior art has provided several solutions, but these are inadequate. For example, prior art mechanisms that secure a paddleboard or surfboard to a fixed object are typically clunky, or require drilling holes into the body of the board, which is of course undesirable as the price of the board may be diminished. Although some products that include locking mechanisms have been disclosed, such designs are fairly elaborate and require many moving parts, which makes these products unnecessarily expensive.

Accordingly, there is an unanticipated need for an anti-theft device or locking mechanism for securing boards, in a manner that is easy to use, and does not require modifying the body of the board, and with a product that is inexpensive or a burden to carry.

Therefore, there are several problems with the current state of the art, which have not been adequately addressed. The problems persist because a need to provide an efficient, cost-effective anti-theft device has not been adequately met. It is to these ends that the present invention has been developed.

### SUMMARY OF THE INVENTION

To minimize the limitations in the prior art, and to minimize other limitations that will be apparent upon reading and understanding the present specification, the present invention describes an anti-theft device or locking mechanism for securing paddleboards or surfboards to an anchoring means or fixed object, thereby preventing the unauthorized removal of the secured board.

A paddleboard anti-theft device, in accordance with an exemplary embodiment of the present invention, comprises: a support body configured to engage with a fin box of a paddleboard, the support body including a frame with one or more openings; a coupling component for traversing one of the openings and attaching the support body to the fin box; and a locking means for preventing access to the coupling component.

A paddleboard anti-theft device, in accordance with another exemplary embodiment of the present invention, comprises: a support body having a cubical frame configured to engage with a fin box of a paddleboard, the support body including a single opening on each surface of the cubical frame; and a coupling component configured to traverse an opening situated on a bottom surface of the cubical frame for securing the support body to the fin box, wherein a first side opening and second side opening are situated on two opposing surfaces of the cubical frame and configured to receive a locking mechanism for anchoring the paddleboard to a fixed object.

A paddleboard anti-theft device, in accordance with yet another exemplary embodiment of the present invention, comprises: a support body configured to engage with a fin box of a paddleboard, the support body including a frame with a plurality of openings on every side of the frame; and a coupling component for traversing an opening situated on a bottom side of the frame, the coupling component for attaching the support body to the fin box.

A method of installing an anti-theft device, in accordance with practice of one embodiment of the present invention, comprises: removing a fin screw of a paddleboard fin box; aligning an opening at the bottom of a cubical frame body of the anti-theft device with a hole for the fin screw; and replacing the fin screw by threading the fin screw through the opening of the cubical frame of the anti-theft device.

Another method of installing a paddleboard anti-theft device, in accordance with practice of one embodiment of the present invention, comprises: (a) aligning an opening at a bottom surface of a cubical frame of an anti-theft device with a corresponding opening on a flat nut situated inside a cavity of a fin box of a paddleboard; (b) inserting a screw into the opening at the bottom surface of the cubical frame; (c) driving the screw into the flat nut to secure the cubical frame at a predetermined position on a surface of the fin box; and (d) threading a locking mechanism through two openings on opposite sides of the cubical frame to prevent access to the screw.

It is an objective of the present invention to provide a device that prevents the unauthorized removal of a board such as a surfboard or paddleboard.

It is another objective of the present invention to prevent theft by restricting access to the fin box of a surfboard or paddleboard.

It is yet another objective of the present invention to provide a means of securely attaching a paddleboard to a fixed object.

It is yet another objective of the present invention to provide a means of securely attaching a paddleboard to a fence.

It is yet another objective of the present invention to provide a means of securely attaching a paddleboard to a vehicle.

It is yet another objective of the present invention to provide a means of securely attaching a paddleboard to a dock.

It is yet another objective of the present invention to provide an inexpensive locking device for use with paddleboards, surfboards, and the like.

These and other advantages and features of the present invention are not set above as limiting objectives, but are described herein with specificity so as to make the present invention understandable to one of ordinary skill in the art.

### BRIEF DESCRIPTION OF DRAWINGS

Elements in the figures have not necessarily been drawn to scale in order to enhance their clarity and improve understanding of these various elements and embodiments of the present invention. Furthermore, elements that are known to be common and well understood to those in the industry are not depicted in order to provide a clear view of the various embodiments of the invention.

FIG. 1(a) illustrates a perspective view of an anti-theft device in accordance with an exemplary embodiment of the present invention, shown coupled to a fin box of a paddleboard and locked in place with a cable and lock.

FIG. 1(b) illustrates a perspective view of an anti-theft device in accordance with an exemplary embodiment of the present invention.

FIG. 2 illustrates a perspective view of an anti-theft device kit in accordance with an exemplary embodiment of the present invention in which a support body comprises a cubical body.

FIG. 3 illustrates a cross-sectional view of an anti-theft device in accordance with an exemplary embodiment of the present invention, shown coupled to a fin box of a paddleboard with a locking means in place to secure the device.

FIG. 4 illustrates an exploded view of an anti-theft device in accordance with the present invention, shown above a fin box from which the fin has been removed.

FIG. 5 illustrates a flowchart of a method of installing an anti-theft device on a paddle board, in accordance with practice of an exemplary embodiment of the present invention.

FIG. 6 illustrates another anti-theft device in accordance with an exemplary embodiment of the present invention.

FIG. 7 illustrates an exploded view of the anti-theft device shown in FIG. 6.

FIG. 8 illustrates a flowchart of a method of installing an anti-theft device on a paddle board, in accordance with practice of an exemplary embodiment of the present invention.

### DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure.

In the following description, a paddleboard or board, may refer to a surfboard, a long board, a short board, a prone board, or any other elongated platform used in water sports such as surfing, paddleboarding, stand up paddle surfing, or stand up paddleboarding, which may be practiced in the open ocean, lakes, or other bodies of water. A locking means may refer to a lock, such as a standard pad lock, a lock with keys, a combination lock, a lockable cable or cable lock, a U-lock, a chain lock, or any other type of locking device. Fin and fin box, refer to the fin and fin support systems commonly implemented by boards, but particularly removable fins. Today, the most common types of fins are removable fins, which may be removed by unscrewing the fin from the paddleboard and be replaced by different fins or be moved about the board (within a predetermined range set out by the dimensions of the fin box). This allows for different configurations that provide alternate forms of maneuverability and stability. While other fin systems—for example glassed-on fins—comprise of fins that are permanently connected to the boards, the removable fin systems are popular because they make it easier to install different style fins into boards, and repair damaged fins. While the present invention could easily be implemented on fixed or permanent fin systems, implementation with removable fin systems maximizes use of the present invention and minimizes potential damage to the board.

Generally, the present invention involves an anti-theft device, or locking mechanism suitable for anchoring a paddleboard to a fixed object. The locking mechanism comprises a support body configured to engage with a fin box of a surfboard. The support body may have various shapes without deviating from the scope of the present invention, but in an exemplary embodiment, the support body includes a cubical frame with one or more openings—for example, an opening on each face of the cubical frame—that enables a locking means, such as a lock or lockable cable to engage with the support body. Because the support body can be securely attached to the fin box of a paddleboard, when the locking means is engaged to the support body, the paddleboard will be secured to a fixed object, and unauthorized removal of the board is prevented. The fixed object may be a dock, a fence, a board rack, a vehicle rack, or any other fixed object to which a paddleboard may be placed against, supported by, or coupled to while the paddleboard is not in use.

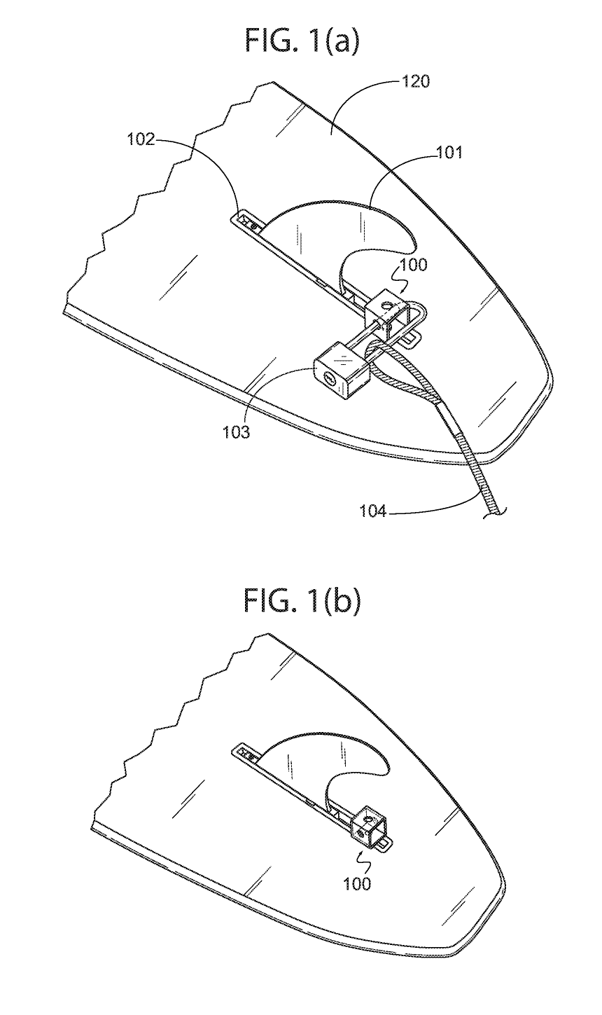

Turning now to the figures, FIG. 1(a) illustrates a perspective view of an anti-theft device in accordance with an exemplary embodiment of the present invention, shown coupled to a fin box of a paddleboard and locked in place with a cable and lock. More specifically, the anti-theft device 100 shown in FIG. 1(a) comprises: a support body 110 configured to engage with a fin box 102 of a paddleboard 120, the support body 110 including a frame with one or more openings; a coupling component (such as a screw 121 and nut 122 not shown in FIG. 1(a)) for traversing one of the openings and securing the support body 110 to a portion of the fin box 102; and a locking means such as a pad lock 103 for preventing access to the coupling component. Accordingly, FIG. 1(a) shows how anti-theft device 100 may be used to secure the board to a fixed object. For example, and without limiting the scope of the present invention, using a locking means such as a pad lock 103 and cable 104, the paddleboard may be secured to a fixed object so as to prevent the unauthorized removal of the board. Without limiting the scope of the present invention, the locking means may be used to secure the board to a fence, a paddleboard rack, a vehicle rack, or any other structure suitable for resting the paddleboard while not in use.

Turning to the next figure, FIG. 1(b) illustrates a perspective view of anti-theft device 100 without pad lock 103 in place. This view illustrates how device 100 may be left installed on the paddleboard when using the paddleboard. Its minimal size and weight allow a paddleboarder to use the board in the water with negligible drag. As will be explained further below with reference to a method of installing device 100, it may be more beneficial to secure the support body 110 of device 100 at a rear portion (as shown in FIG. 1(a)-(b)) so as to minimize drag, although the design of the support body should be such so as to minimize interference whether it is installed in front of or behind the fin of the board. Accordingly, the support body may be kept installed on the board (as shown in FIG. 1(a)-(b)) while the board is being used, or may be removed depending on the user' s preference. For some uses, removal may be desired, such as uses with shorter boards that may suffer more from drag. With larger boards, such as paddleboards, the anti-theft device may be left in as drag is less of a factor—especially if placed at a rear portion of the fin of the board.

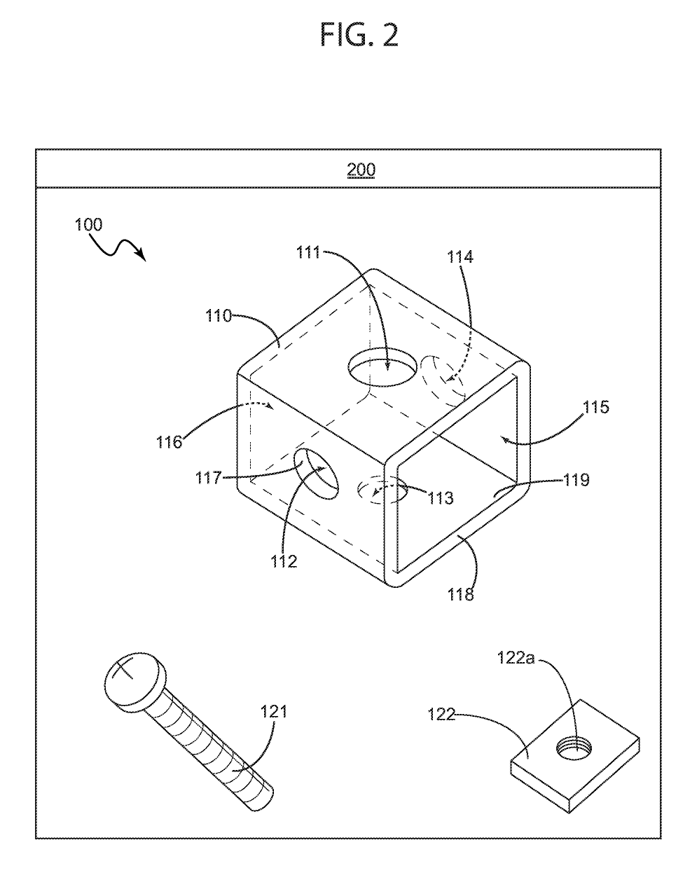

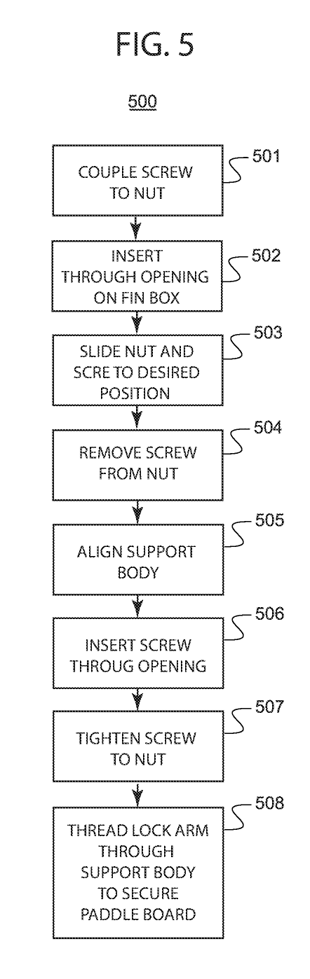

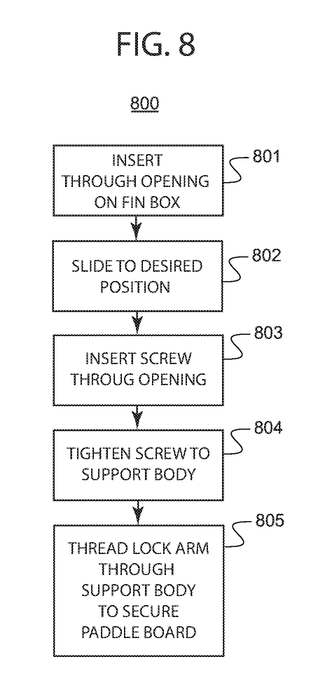

Proceeding with the next figure, FIG. 2 illustrates a perspective view of an anti-theft device kit 200, in accordance with an exemplary embodiment of the present invention. More specifically, kit 200 may include device 100 comprising components that may or may not be included with a paddle board. For example, although a coupling component may be a screw and nut that are already existent on the fin box of the paddle board, a kit in accordance with the present invention may include a coupling component or screw 121 and nut 122 for securing device 100 to the fin box of the paddleboard. Accordingly, an exemplary kit 200 may comprise: device 100, which includes support body 110, a screw 121, and a nut 122. In some exemplary embodiments, a small screw driver or similar tool may be included as well to allow users to install the anti-theft device without needing to acquire any other tools or components on their own. Generally, installation and use instructions may be included with kit 200—variations of installation instructions further discussed below with reference to FIG. 5 and FIG. 8.

Support body 110 may comprise different shapes and sizes without deviating from the scope of the present invention, but in the exemplary embodiment of FIG. 2, support body 110 comprises a cubical or substantially cubical frame that includes a plurality of openings—a single opening on each face of the cubical frame. More specifically, support body 110 of anti-theft device 100 may comprise a cubical frame configured to engage with fin box 102 of paddleboard 120, the support body 110 including openings 111-116, a single opening on each surface or face of the cubical frame.

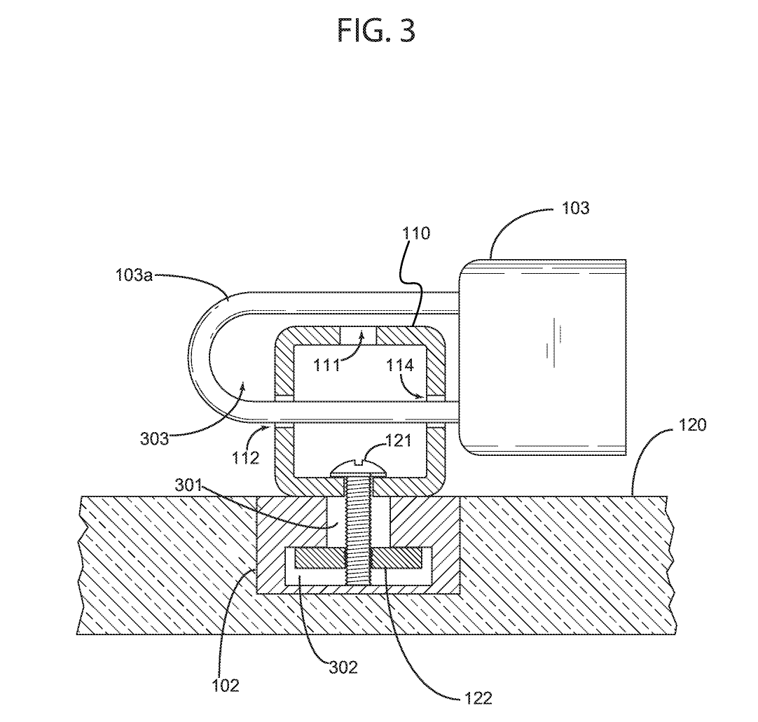

In such exemplary embodiment, support body 110's cubical frame includes six faces, four of which include walls (such as wall 117), with the two remaining faces of the cubical frame without walls. This structure or configuration of support body 110 is especially useful to prevent theft but facilitate the installment of the anti-theft device onto a paddle board. The smaller openings 111-114 are suitable for receiving and traversing a portion of a screw driver and or a portion of a screw, such as screw 121, as well as for receiving a portion of a locking means such as a portion of a security cable or a pad lock shackle such as shackle or arm 103a (see FIG. 3); more specifically, openings 112 and 114 facilitate the placement of a locking mechanism 103 (such as a pad lock and or cable 104) to secure the paddleboard to which the device has been attached. Of course, in an alternative embodiment, on one of the sides—for example on the face or surface where opening 116 is located there could be a solid surface rather than the opening. This may be desirable to further strengthen the device, but may not facilitate the inserting of screw 121 into opening 113 as is facilitated with both opposite sides having the openings 115 and 116.

At least two of the openings on the frame of support body 110 includes a first opening 115 and a second opening 116, which are situated on opposing sides of the cubical frame and are generally wider than the openings on the remaining faces of the cubical frame of support body 110 because they lack a frame wall such as wall 117 but rather comprise of a border such as border 118. The wider openings 115 and 116 may be wider to facilitate the placement of a coupling component such as screw 121 through the bottom opening 113 of the cubical frame of support body 110 of device 100. As will be discussed below, this facilitates the installment process. Accordingly, in an exemplary embodiment openings 115 and 116 situated on opposite sides of the cubical frame of support body 110 comprise of wide openings surrounded by a border 118 having a thickness substantially equal to the thickness of each surface of the cubical frame.

As can be appreciated from FIG. 1 and FIG. 3, although the wider openings 115 and 116 clearly expose a portion of the interior of support body 110, once locking mechanism 103 is secured in place, an unauthorized user cannot adequately access the coupling component or screw 121 and nut 122 in order to, for example, attempt to remove the coupling component—by for example attempting to unscrew or otherwise decouple screw 121 and nut 122—because the locking means such as pad lock 103 typically conceals, gets in the way or prevents access to screw 121. During installation, however, a user could utilize their fingers to manually insert the screw 121 via wider openings 115 and 116 to guide screw 121 through opening 113 at the bottom surface 119 of support body 110; once screw 121 is partially placed snuggly through opening 113, a screw driver or similar tool configured to register with screw 121, may be guided through opening 111 in order to drive screw 121 into fin box 102 and secured with nut 122.

It should be noted that typically, in exemplary embodiments, the circumference of opening 113 (and 114) are smaller than at least one circumference of a coupling component or screw 121 so that screw 121 can be secured against fin box 102. For example, and without limiting the scope of the present invention, in FIG. 2, screw 121 is a typical screw having a wider circumference at its head than at its threaded body; accordingly, opening 113 includes a circumference that is larger than the threaded body of the screw but smaller than the head of the screw. In such exemplary embodiment, opening 111 is of identical size as opening 113 and configured with a circumference suitable for receiving a screw driver sized to interact with screw 121. As will be explained with regards to a method of installing device 100, while the wider openings 115 and 116 are suitable for a user to manually place or insert a screw into opening 113, opening 111 may be used to insert a screwdriver therethrough and drive the screw into a portion of the fin box. As such, screw 121 may traverse opening 113 interact or register with the threaded component of nut 122 and be secured in a manner so that a head of the screw 121 rests on bottom surface 119 of support body 110 of device 100.

In some embodiments, all openings may be similarly sized with similar circumferences and centered on each face of the cubical frame. In other exemplary embodiments, openings 112 and 114 are slightly larger than openings 111 and 113 so that openings 112 and 114 may receive larger and thus typically stronger locking means such as larger lock pads or locking cables. In the shown embodiment of FIG. 2 (and for example FIG. 3) each opening of the cubical frame of support body 110 is not threaded; this may be desirable to facilitate installation as it may be easier, for example, to insert screw 121 via opening 113 without requiring the screw to register with threads on a surface of the opening. Furthermore, excluding threads may be desirable so that the size of the cubical frame can be minimized as screw 121 may be inserted at a slight angle. Alternatively, a threaded opening may require screw 121 to properly engage and as such the size or height of the frame may have to be increased or the size of the screw decreased to facilitate installation. Nevertheless, each opening may be or may not be threaded without deviating from the scope of the present invention.

In exemplary embodiments, opening 111 and opening 113 have substantially the same circumference and a head of screw 121 will not pass through the openings. However, in other exemplary embodiments, only opening 113 situated at a bottom surface of the cubical frame of support body 110 will have a circumference that prevents the head of screw 121 from passing through the opening, and opening 111 may be wide enough to allow the head of screw 121 to pass through. This may be desirable to allow easier installation through opening 111 situated on a top surface of the cubical frame of support body 110. However, having each opening on top and bottom (111 and 113 for example) of equal or substantially the same circumference may allow a user to install the device in either way. Similarly, openings 112 and 114 are similar in circumference and either both centrally situated on each respective surface or both similarly situated in their respective surface of the cubical frame so that a padlock arm that is threaded through is properly aligned therein.

In an exemplary embodiment, the openings are sized in a manner so that only the bottom opening 113 may be used to receive screw 121, while openings 111, 112, and 114 are slightly smaller. In this way, when the pad lock is secured, an unauthorized individual will not be able to remove the screw from any of the other openings.

Screw 121, as mentioned above, may be configured to traverse one of the openings 113 situated on a bottom surface of the cubical frame for securing support body 110 to fin box 102. Although a screw is typically desired, other coupling means may be implemented without deviating from the scope of the present invention. In exemplary embodiments, coupling component 121 is a screw that is sized to partially traverse through opening 113 and configured with threading that registers with nut 122. Of course, screw 121 may be any kind of screw such as a Frearson screw, Phillips screw, torx screw, square slot screw, a slotted screw, a hex socket screw, or any other type of similar device suitable for securing into the support body into the fin box of the board.

Nut 122 may be any size or shape, but in exemplary embodiments comprises of a small rectangular shape that has generally a length configured to or suitable for inserting into a cavity of the fin box. As will be explained in more detailed below (i.e. see FIG. 3) nut 122 may be inserted inside said cavity so that nut 122 can be secured in place when registered with a portion of screw 121; this way, support body 110 of device 100 may be secured against a surface portion of the fin box.

Support body 110 may be of various sizes without deviating or limiting the scope of the present invention, and cubical as used in this disclosure generally means substantially cubical or having the general shape of a cube with six faces or surfaces; however cubical may include a cube, or a cubical shape having two square surfaces and the remaining surfaces slightly elongated so that the longer faces comprise rectangular perimeters, or similar variations therein. In exemplary embodiments, however, support body 110 may have a 1-inch length for each of its side surfaces (i.e. including openings 112, 114, 115, and 116) and 1-inch length for both its top surface (i.e. including opening 111) and bottom surface (i.e. including opening 113).

Similarly, support body 110 may be constructed of a variety of materials and using known methods without deviating from the scope of the present invention. For example, support body 110 may be constructed of plastics or light weight metals. In an exemplary embodiment, support body 110 is constructed using materials such as polycarbonates or similar thermoplastic polymers, which are strong, light-weight materials that are also weather resistant.

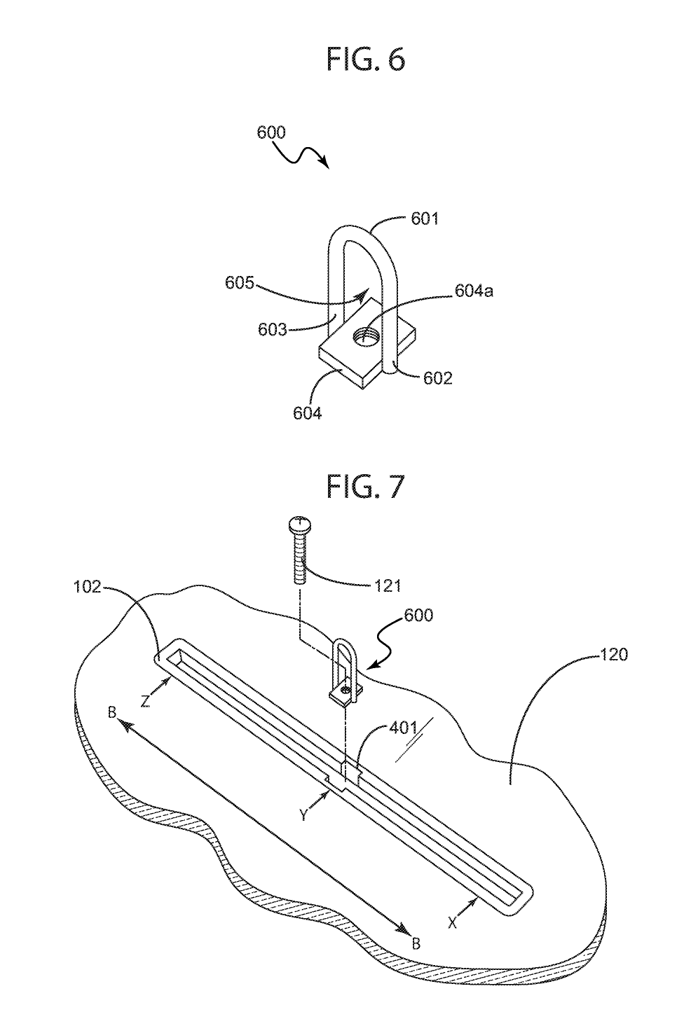

As mentioned above and shown in FIG. 2, support body 110 includes a cubical frame with six faces (four substantially closed faces such as bottom face or surface 119, and two open faces such as opened face or opening 115 with border 118), wherein the three surfaces of the cubical frame (i.e. the surfaces including openings 112, 111, and 114) bridge over or arch over the bottom flat or planar surface 119 of support body 110. However, in alternative embodiments, the support body may include a cylindrical shape, an elongated shape, or any other shape that may be suitable for placing in front or at a rear portion of the fin of the board. As will be discussed in some detail below, in another exemplary embodiment, the support body may comprise of a cylindrical elongated body defined by two prongs integral or coupled to a flat or planar bottom surface that is generally perpendicular to the cylindrical elongated body. The planar surface is designed to engage with the fin box and the cylindrical elongated body is designed with an opening for interfacing with a locking means such as a pad lock or cable. Other shapes may be implemented; however, the shape of the support body preferably does not interfere with use of the board so that it may be left on the board during the board's use. See FIG. 6 through FIG. 8 below.

FIG. 3 illustrates a cross-sectional view of an anti-theft device in accordance with an exemplary embodiment of the present invention, shown coupled to a fin box of a paddleboard with a locking means. More specifically, FIG. 3 depicts support body 110 of device 100 secured onto fin box 102 of paddle board 120, wherein pad lock 103 has been secured to support body 110 by traversing or inserting a portion thereof such as pad lock shackle or arm 103a through openings 112 and 114. Screw 121 has been traversed through opening 113 on bottom surface 119 of support body 110 and through a first cavity 301 into a second cavity 302 of fin box 102 of paddle board 120.

Once pad lock 103 is secured to support body 110 as shown, an opening 303 created by the shackle or arm 103a of pad lock 103 and support body 110 allows insertion of a support member or fixed structure to which the paddle board may be secured. As mentioned above, the support member may be a cable or a chain that is in turn secured around a structure such as a vehicle rack or fence; or the support member may be a fixed structure itself, such as a portion of a board rack or similar support structure provided for standing up paddleboards in place.

As can be appreciated from this view, the first cavity 301 (of fin box 102) is narrower than the second cavity 302 (of fin box 102). Furthermore, nut 122 fits laterally inside the lower channel or cavity 302 but not the upper channel or cavity 301 so as to facilitate the secured coupling of support body 110 with screw 121. As mentioned above, this configuration for a fin box is typical of paddle boards and insertion of nut 122 into the cavities of fin box 102 can be achieved by simple means as will be explained below with reference to the next figure.

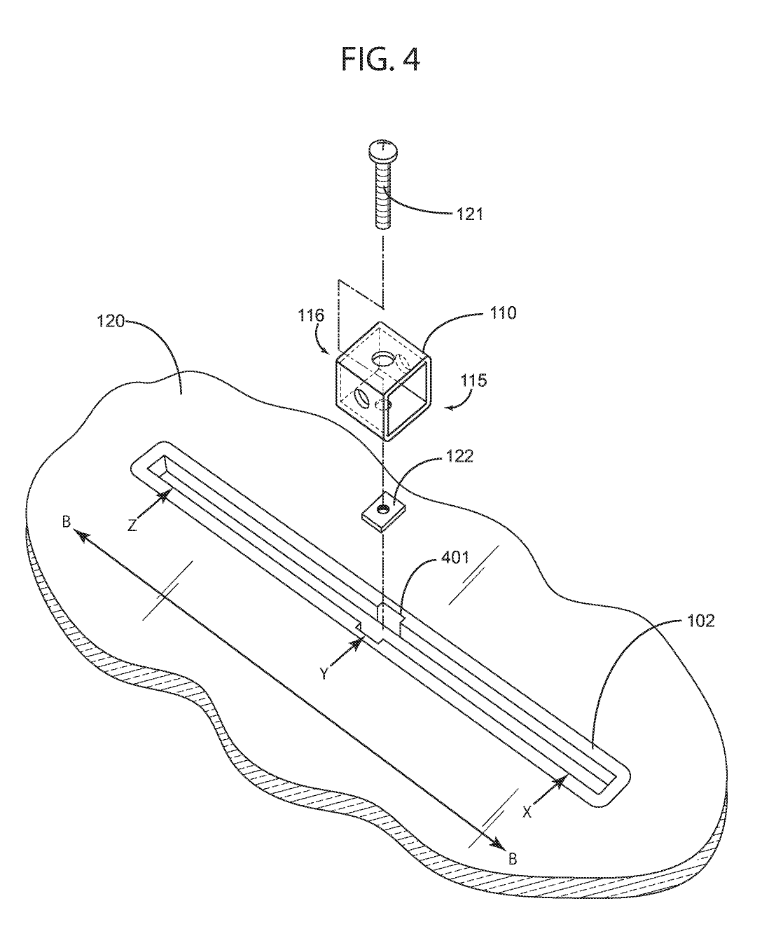

FIG. 4 illustrates an exploded view of an anti-theft device in accordance with the present invention, shown above a fin box from which the fin has been removed. More specifically, FIG. 4 depicts how an anti-theft device in accordance with the present invention, may be installed onto a fin box of a paddleboard. As may further be appreciated from this view, screw 121 may be inserted, as mentioned above, by manually placing or traversing the screw through one of the wider openings on a side face of support body 110, such as opening 116 (as shown) or opening 115. With nut 122 in a desired position Z or X, and support body align with nut 122, screw 121 may be driven to register and secure against nut 122.

In the shown embodiment, the fin that typically is installed on fin box 102 has been removed to expose aperture 401, which is a wider opening that leads through to the bottom of fin box 102 via the first narrower cavity 301 and to the wider cavity 302. Because aperture 401 is as wide as second cavity 302, nut 122 may be slid into a desired position along a length B of fin box 102 (for example at position X, see discussion below with regards to method 500). It should be noted that different fin boxes designs may include more than one aperture such as aperture 401 and the embodiment shown in FIG. 4 is merely for illustrative purposes and explaining how nut 122 may be inserted and installed on the fin box.

Installation of an anti-theft device in accordance with the present invention is fairly straight forward. For example, and without limiting the scope of the present invention, a method of installing a paddleboard anti-theft device, may comprise of (a) removing a fin screw of a paddleboard fin box; (b) aligning an opening at the bottom of a cubical frame body of the anti-theft device with a hole for the fin screw; and (c) replacing the fin screw by threading the fin screw through the opening of the cubical frame of the anti-theft device and thereby securing the support body to the board.

Turning now to the next figure, FIG. 5 illustrates a flowchart of an exemplary method of installing an anti-theft device on a paddle board, in accordance with practice of an exemplary embodiment of the present invention. Naturally, the steps of method 500 should not be limiting, and these steps and additional steps may be performed in the same sequence or alternative sequence without deviating from the scope of the present invention.

In step 501, screw 121 may be coupled to or threaded onto nut 122 (without support body 110) so that the screw and nut are coupled together on their own. This step may be desirable if a nut suitable for engaging or registering with screw 122 is not already in a desired position such as at position Z (in front of the fin) or at position X (behind the fin) on fin box 102. Alternatively, this step may be skipped if a proper nut is already at a desired position such as position X.

In step 502, the coupled screw 121 and nut 122 may be inserted in aperture 401 of fin box 102 so that nut 122 lays flat on a bottom surface of second cavity 302 of fin box 102. Again, this step may be desirable if a nut suitable for engaging or registering with screw 122 is not already in a desired position such as at position Z (in front of the fin) or at position X (behind the fin) on fin box 102. Alternatively, this step may be skipped if a proper nut is already at a desired position such as position X.

In step 503, using a top portion pf screw 121 (screw 121 being coupled or screwed onto nut 122), the screw 121—nut 122 coupling component may be slid across a length B (see FIG. 4) of second cavity 302 of fin box 102 to a desired position. In exemplary practice of the present invention, coupling component (screw 121 and nut 122) are slid to position X.

In step 504, and once coupling component (screw 121 and nut 122) is in position X, screw 121 may be unscrewed or decoupled from nut 122 leaving nut 122 in place inside cavity 302 of fin box 102, having the threaded portion or opening of nut 122 exposed through cavity 301 of fin box 102.

In step 505, support body 110 may be aligned with nut 122 so that opening 113 at the bottom surface 119 of support body 110 lines up with the threaded opening 122a of nut 122. In step 506, screw 121 may be inserted into opening 113 through opening 116 (or opening 115) typically tilting screw 122 slightly (depending on the size of support body 110). In exemplary practice, support body 110 is large enough and screw 121 is small enough so that inserting screw 121 into opening 113 (but prior to engaging or threading with nut 122) enables screw 121 to stand right up and perpendicular to surface 119. For example, and without deviating from the scope of the present invention, this may be achieved by constructing the cubical frame of support body 110 so that border 118 and wall 117 have an equal thickness and screw 121 is sized so that it may fit inside the cubical frame. This configuration, allows a portion of a screw driver to be inserted via opening 111 on the top face or top surface of support body 110 in order to screw and secure screw 121 with nut 122.

Finally, in step 508, with the support body and coupling component coupled together in place against the fin box, the anti-theft device is secured to the paddleboard. In order to secure it to a fixed object, a lock arm or pad lock shackle such as arm 103a may be threaded through openings 112 and 114 as shown in FIG. 1 and FIG. 3. As mentioned above, the anti-theft device need not be removed when the paddle board is in use, however in order to uninstall, the steps of method 500 may be performed in reverse.

Turning to the next figures, FIG. 6 illustrates another anti-theft device in accordance with an exemplary embodiment of the present invention, and FIG. 7 illustrates an exploded view of the anti-theft device shown in FIG. 6. As mentioned above, support body 110 may be of various shapes without deviating or limiting the scope of the present invention; in the embodiment depicted on FIG. 6, support body 600 comprises of a frame having a support member bridging or arching over a planar surface, in a similar manner in which the three surfaces of the cubical frame shown in FIG. 2 (i.e. including openings 112, 111, and 114) bridge or arch over surface 119 of support body 110. However, in the embodiment depicted on FIG. 6, support body 110 includes a support member that is cylindrical or tubular, and an elongated support member 601, which generally bridges over or arches over planar surface 604. As such, the elongated support member 601 may be defined in part by two prongs 602 and 603 that are integral or coupled to a flat lateral portion or planar surface 604 forming an opening 605; prongs 602 and 603 should be sized so that each prong 602 and 603 can be received by the narrower top channel or cavity 301 of fin box 102.

Elongated member 601 is preferably although not necessarily perpendicular to the planar surface 604. As mentioned above the elongated member may be tubular or generally cylindrical, but may be rectangular or of varying shapes without deviating from the scope of the present invention so long as the structure creates an opening 605 suitable for receiving a locking means such as a pad lock or locking cable.

The planar surface 604 is designed to engage with the fin box much like nut 122 in the previously shown embodiment. And the elongated member 601 is designed with an opening 605 for interfacing with a locking means such as a pad lock or cable. To these ends, prongs 602 and 603 may be coupled to planar surface 604 at the longer sides of planar surface 604.

Note that in this embodiment, there is no need for nut 122 as the flat lateral portion is of a size and shape that enables support body 600 to be inserted into the cavities of fin box 102 using a similar installation method.

Further, support body 600 may be constructed of a wide variety of materials so long as the device is durable and light weight. In an exemplary embodiment, support body 100 is constructed of a light but strong metal or plastic. Moreover, in an exemplary embodiment, opening 605 is only wide enough to allow a pad lock arm to traverse through, but not so wide that an unauthorized individual could access screw 121 in order to remove the anti-theft device from the board.

Turning now to FIG. 8, a flowchart depicts one method of installing an anti-theft device on a paddle board, in accordance with practice of an exemplary embodiment of the present invention. Naturally, the steps of method 800 should not be limiting, and these steps and additional steps may be performed in the same sequence or alternative sequence without deviating from the scope of the present invention.

In step 801, support body 600 may be inserted in aperture 401 of fin box 102 so that flat lateral portion 604 lays flat on a bottom surface of second cavity 302 of fin box 102.

In step 802, using elongated cylindrical portion 601, support body 600 may be slid across a length B (see FIG. 7) of second cavity 302 of fin box 102 to a desired position. In exemplary practice of the present invention, support body 600 is slid to position X.

In step 803, and once support body 600 is in position X, screw 121 may be inserted into opening 604a through opening 605. And in step 804, screw 121 may be tightened to secure support body 600 against a surface of fin box 102.

Finally, in step 805, with the support body and coupling component coupled together in place against the fin box, the anti-theft device is secured to the paddleboard. In order to secure it to a fixed object, a lock arm or pad lock shackle such as arm 103a may be threaded through opening 605. As mentioned above, the anti-theft device need not be removed when the paddle board is in use, however in order to uninstall, the steps of method 800 may be performed in reverse.

The procedures or methods described above may be practiced in reverse in order to remove the anti-theft device from the board. Moreover, it should be pointed out that the support body may be placed in alternative configurations without deviating from the scope of the present invention. For example, the support body of the anti-theft device may be placed at a front end of the fin (e.g. position Z on FIG. 4 or FIG. 7), or at a back or rear portion of the fin (e.g. position X on FIG. 4 or FIG. 7). Typically, it may be beneficial to secure the support body at a rear portion so as to minimize drag, although the design of the support body should be such so as to minimize interference. Accordingly, the support body may be kept installed on the board while the board is being used, or may be removed depending on the user preferences. For some uses, removal may be desired, such as uses with shorter boards that may suffer more from drag. With larger boards, such as paddleboards, the anti-theft device may be left in as drag is less o f a factor—especially if placed at a rear portion of the fin of the board.

Similarly, as illustrated in the embodiments disclosed above, an anti-theft device in accordance with the present invention may have various shapes, sizes, and constructed of a wide range of materials. Because the support body can be securely attached to the fin box of a paddleboard, when the locking means is engaged to the support body, the paddleboard will be secured to a fixed object, and unauthorized removal of the board is prevented. The fixed object may be a dock, a fence, a board rack, a vehicle rack, or any other fixed object to which a paddleboard may be placed against, supported by, or coupled to while the paddleboard is not in use.

A paddleboard anti-theft device and method has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

1. A paddleboard anti-theft device, comprising:
a support body having a cubical frame configured to engage with a fin box of a paddleboard, the support body including at least a single opening on each surface of the cubical frame; and
a coupling component configured to traverse an opening situated on a bottom surface of the cubical frame for securing the support body to the fin box, wherein a first side opening and a second side opening are situated on a first set of opposing side surfaces of the cubical frame and configured to receive a locking mechanism for anchoring the paddleboard to a fixed object.

2. The device of claim 1, wherein:
an opening situated on a top surface of the cubical frame is aligned with the opening situated on the bottom surface of the cubical frame.

3. The device of claim 1, wherein:
the first side opening and the second side opening situated on the first set of opposing side surfaces of the cubical frame comprise of aligned apertures.

4. The device of claim 1, wherein:
the first side opening and the second side opening situated on the first set of opposing side surfaces of the cubical frame comprise of apertures with substantially the same circumference.

5. The device of claim 1, wherein:
a third side opening and a fourth side opening situated on a second set of opposing side surfaces of the cubical frame comprise of wide openings surrounded by a border having a thickness substantially equal to the thickness of each surface of the cubical frame.

6. The device of claim 1, wherein the coupling component comprises:
a screw that traverses the opening situated on the bottom surface of the cubical frame; and
a nut configured to register with a cavity of the fin box and receive a threading on the screw.

7. The device of claim 1, wherein the locking mechanism means comprises a pad lock.

8. The device of claim 1, wherein the locking mechanism comprises a cable.

9. A paddleboard anti-theft device, comprising:
a support body configured to engage with a fin box of a paddleboard, the support body including a frame with a support member bridging over a single opening situated on a bottom planar surface of the frame; and
a coupling component configured to traverse the single opening situated on the bottom planar surface of the frame, the coupling component for securing the support body to the fin box of the paddleboard.

10. The device of claim 9, wherein the coupling component comprises:
a screw that traverses the single opening situated on the bottom planar surface of the frame.

11. The device of claim 9, wherein:
the support member comprises an elongated member that forms an arch over the planar surface and includes two prongs that are integral or coupled to opposite sides of the bottom planar surface.

12. The device of claim 11, wherein:
the planar surface is perpendicular to the elongated member.

13. The device of claim 9, wherein:
the frame comprises a cubical frame including:
a first side opening and a second side opening, each situated on a first set of opposite surfaces of the cubical frame and having a substantially equal circumference; and
a third side opening and a fourth side opening, each situated on a second set of opposite surfaces of the cubical frame, the third and fourth side openings having a greater width than the first and second side openings.

14. The device of claim 13, wherein:
the third and the fourth side openings situated on the second set of opposite sides of the cubical frame comprise of wide openings surrounded by a border having a thickness equal to the thickness of each surface of the cubical frame.

15. The device of claim 9, further comprising:
a locking mechanism for preventing access to the coupling component.

16. A method of installing a paddleboard anti-theft device, comprising:
(a) aligning an opening at a bottom surface of a cubical frame of an anti-theft device with a corresponding opening on a flat nut situated inside a cavity of a fin box of a paddleboard;
(b) inserting a screw into the opening at the bottom surface of the cubical frame;
(c) driving the screw into the flat nut to secure the cubical frame at a predetermined position on a surface of the fin box; and
(d) threading a locking mechanism through two openings on opposite sides of the cubical frame to prevent access to the screw.

17. The method of claim 16, further comprising:
(e) prior to steps (a) through (b), inserting the flat nut of the anti-theft device into the cavity of the fin box of the paddleboard via an aperture on the fin box; and
(f) sliding the flat nut inside the cavity of the fin box into the predetermined position.

18. The method of claim 17, further comprising:
(g) prior to step (e), driving a portion of the screw directly into the flat nut; and
(h) subsequent to step (f) removing the screw from the flat nut once the flat nut is slid into the predetermined position.

19. The method of claim 16, wherein:
driving the screw into the flat nut to secure the cubical frame at the predetermined position on the surface of the fin box comprises inserting a screw driver through a top opening on a top surface of the cubical frame of the anti-theft device.

20. The method of claim 16, wherein:
threading a locking mechanism through two openings on opposite sides of the cubical frame comprises threading a pad lock arm through the two opening to prevent access to the screw.
